(19) United States
(12) Patent Application Publication
(10) Pub. No.: US 2026/0026439 A1
(43) Pub. Date: Jan. 29, 2026

(54) MODULAR AUGER UNIT AND HARVESTER HEADER

(71) Applicant: CARLOS MAINERO Y CIA. S.A.I.C.F.I., Bell Ville (AR)

(72) Inventor: Carlos Oscar Mainero, Bell Ville (AR)

(21) Appl. No.: 19/266,957

(22) Filed: Jul. 11, 2025

(30) Foreign Application Priority Data
Jul. 26, 2024 (AR) P20240101973

(51) Int. Cl. A01D 61/00

(52) U.S. Cl. CPC A01D 61/004

(57) ABSTRACT

A harvesting header having a transversal collector-conveyor auger, having a main module and lateral modules to extend its working width. Module end flanges are a pin-guides for preliminary alignment. Thereafter bolts are inserted inside a threaded bushing screwed into one of the flanges until it bottoms out against the other flange having a smaller hole to allow only the bolt to pass. The bolt is tightened with a nut and the bushing with a locknut. Auger modules are interconnected by an internal sleeve fitting across the tubular ends of each module. One sleeve portion includes a first ring fixed inside the module by welding studs applied through perforations in the auger tube and a second ring is joined to the tube end by a weld seam. The other portion has a second pair of rings with threaded holes to receive bolts passing through the wall of the other auger module.

### CROSS-REFERENCE TO RELATED APPLICATIONS

Not applicable.

### FIELD OF THE INVENTION

The present invention pertains to the technical field of agricultural machinery and is applicable to harvesting machines, particularly to crop gathering headers. It specifically concerns the conveying unit for the harvested material and the structural frame on which said conveying unit is mounted. Furthermore, the present invention relates to very-wide harvesting headers.

Among its various applications, particular relevance is found in auger conveyor units of sunflower harvesting headers.

### BACKGROUND OF THE INVENTION

A harvesting machine typically includes exchangeable headers that can be rapidly coupled to the machine and are used to gather the crop material and deliver it for processing while the machine moves across the field. The headers referred to in the present invention generally include components that cut or detach the portion of the crop to be processed by the harvester and, subsequently, a pair of concentric collecting augers—optionally working in conjunction with a pair of concentric conveyor belts—with spiral flights or blades wound in opposite directions on either side of a central feeder mouth, in order to smoothly and orderly convey the cut or collected material along a tray toward the feeder mouth at the center of the header, where it is transferred to the harvester's main conveyor for further processing.

The number of augers and the number of segments composing each auger primarily depend on the working width of the header, since manufacturing constraints make it difficult to exceed a width of 7 meters with a single-piece auger. Wider headers generally consist of multiple auger segments, where the drive is either transmitted from one segment to the next or each segment is independently driven from the side. In headers exceeding 12.2 meters (40 feet) in total width, in addition to comprising two augers, both the header frame and its components—including the augers—are typically constructed in modular fashion on at least one side, for the purpose of disassembled transport thereof in shipping containers.

The number of crop dividers or pans mounted on the sunflower header frame determines the width of the header. The more units there are, the wider the header and the shorter the time required to harvest a given field. However, the overall weight of the header also increases, placing greater demand on the harvester. Weight is a significant limiting factor in the overall header width.

On the other hand, for the purpose of transporting harvesting headers from one location to another—especially via maritime shipping for export to overseas countries—, there is a width limitation of approximately 12.2 meters (40 feet). In the case of sunflower harvesting headers, this limits the number of pans to twenty-four when the row spacing is 52.5 centimeters (the most commonly used in Argentina), or fewer pans for larger row spacings, such as 70 centimeters (commonly used in countries like Russia).

### PRIOR ART

U.S. Pat. No. 3,072,243 (Link-Belt) discloses an auger coupling mechanism comprising a circular rod inserted into the ends of adjacent augers and supported by a bearing mounted from above. Two bolts, positioned at 90 degrees to each other, rigidly secure the auger-rod assembly.

U.S. Pat. No. 3,540,195 (van Der) discloses a mower comprising two rigidly interconnected bodies.

U.S. Pat. No. 3,977,164 (Massey-Ferguson) discloses a combined harvester (“combine”) with two auger halves rigidly joined at their inner ends with central supports.

U.S. Pat. No. 4,487,004 (Kejr) discloses an auger formed by articulated sections.

Chinese Utility Model CN 203158726 U describes a three-section auger assembly connected via sleeves and supported at the center by bearings.

European Patent EP 3,229,579 B1 (CNH) discloses a grain harvester header constructed in articulated sections to facilitate operation with longer headers on uneven or undulating terrain. Each header section (e.g., three) supports a corresponding segment of a collecting auger, with successive auger sections connected via cardan-type rotating articulated joints to enable the transmission of rotational power along the entire length of the collecting auger.

European Patent EP 3,434,098 B1 (Deere) discloses a harvesting header featuring augers divided into a central horizontal module joined at both ends to two outer oblique segments that rise toward the center module to accommodate progressively increasing grain flow toward the center of the header. The outer segments are connected to the central module via rotary joints, such as universal (cardan) joints, providing torque transmission between non-coaxial shafts.

U.S. Pat. No. 11,758,850 B2 (Deere) discloses a harvesting machine comprising two (or more) gathering augers mounted to the chassis and interconnected via a rotary mechanism that transmits torque from one auger to the other. In one embodiment, the rotary mechanism comprises a hexagonal bar that fits into hexagonal openings centred at the facing ends of both augers, enabling selection of various relative rotational position (in 60° increments, i.e. six positions) of one auger with respect to the other. In another embodiment, the rotary mechanism includes a plate that links one auger to the other at various rotational positions, determined by a set of orifices in the plate through which it is bolted to the end of the other auger. This system allows selecting different discontinuities between the spiral flights of the two augers.

### Technical Problems

Modern wide-working-width headers incorporate more than one auger and often more than one segment per auger. The method known in the prior art for supporting the inner ends—with the outer ends supported by the chassis—involves bearing housings and bearings mounted on support plates connected to the main frame. However, these support plates and the necessary discontinuity in the auger flights (to avoid interference with the support structure) restrict the flow of material. On the other hand, and related to the mentioned flow restriction, those supports tend to wrap plant material, causing poor performance, transmission overload, and even breaks on the bearings. Another drawback of such supports where torque is transmitted from one segment to the next is the requirement for extremely precise alignment to avoid damage on the drive shafts, making it difficult both its initial assembly and in-field adjustment. See patents EP 3,229,579 B1, EP 3,434,098 B1, and U.S. Pat. No. 11,758,850 B2 cited above.

One of the technical problems addressed by the present invention is to provide a harvesting header with a greater number of crop dividers or pans, and that exceeds said width limitation, particularly (though not exclusively) for export and transport in standardized-length shipping containers. This problem is not solved simply by manufacturing the head in two parts or modules; rather, to begin with, the joint between the main frame modules must support the weight of the cantilevered module, especially under demanding working conditions in the field.

Furthermore, partitioning the header into two parts implies doing the same not only with the main frame but also with other components that extend transversely from one side arm of the main frame to the other, spanning the full width of the header, which is precisely the origin of the underlying design constraint. For the auger in particular, modularization poses a greater challenge, because the connection between auger modules must be torque-transmitting without impeding material flow; that is, it must not interfere with the auger's primary function of efficiently transporting harvested material from the sides of the header toward the center where the feeder mouth is located, with smooth transition across the joint zone.

Both auger modules must maintain highly accurate collinearity to prevent vibrations during operation under load, as such vibrations can drastically reduce the service life of the header. This requirement rules out the use of welded joints, due to the thermal distortion commonly induced by welding on metal components. This issue is exacerbated in cases where, for constructional reasons, one of the modules is cantilevered. Given the length and load carried by the auger assembly, even minute deviations from axial straightness can result in unacceptable vibration levels.

Thus, it is convenient to use a coupling means that passes through the interior of the auger's tubular shafts. However, an internal coupling such as a sleeve-type connector exhibits assembly challenges in achieving precise alignment, due to the tendency of the sleeve to slide inside the tube during assembly if it cannot be subsequently secured or if its exact positioning cannot be visually confirmed.

### SUMMARY OF THE INVENTION

A primary object of the present invention is to increase the number of crop dividers or pans in a harvesting header to the extent that it may exceed the previously acceptable maximum header width, particularly (though not exclusively) for export purposes.

The present invention achieves this first object by providing a harvesting header equipped with a collecting and conveying auger mounted within a structural chassis, the rear frame of which spans the entire width of the header and is partitioned into at least two structural modules that may be assembled via reciprocal fastening devices provided on both chassis modules. Each module is equipped with components such as sickle bar, stalk puller, reel, shiel and the collecting-conveying auger, thereby extending the modular approach to all components mounted transversely across the chassis.

The length of the larger module or main module 11 of the header may conveniently be close to the aforementioned limit, encompassing the header mounting assembly on the harvesting machine, as well as the feederhouse frame and central drive mechanism concentrated in the central section 12 of the header to which one of the lateral extensions 13 is integrated, terminating at an end terminal 14 of the header, so as to minimize the load on the other lateral extension formed by the smaller, cantilevered module 16. The latter smaller, cantilevered module 16 forms the other lateral terminal 17 of the header, as represented schematically in FIG. 1A. The smaller module 16 may constitute the right-hand lateral extension of the sunflower header, whereas the main module 11 comprises the central portion of the sunflower header—where the central drives for the sickle bar and auger are located—and the left-hand lateral extension 13, which includes the stalk puller drive on its outermost terminal 14. The respective auger supports are mounted on the lateral terminals 14 and 17.

In an alternative configuration, represented schematically in FIG. 1B, the header is formed by a central module 11′ housing the central drives for the sickle bar and auger. To extend the width of the header, lateral extension modules 16D and 161 are bolted to the sides of the central module, with the lateral stalk puller drive located in the terminal 14 of one of the extensions. Optionally, if the central module has sufficient length to cover the total working width, it may be used without the lateral modules, in which case the terminals with the auger supports and stalk puller drive are directly bolted to the central module 11′.

The reciprocal fastening devices may comprise flanges 18 located on the sides of both the main module and the modular extensions, which are bolted together, prior to bolting the lateral stalk-puller drive to the outer end of the left-hand extension to close the corresponding terminal.

Advantageously, the flanges 18 on the extensions are provided with guides that allow a quick and easy initial engagement with the main module, enabling the preliminary alignment of the two sections. Once both modules are engaged, the flanges are bolted together for a solid and straightforward connection.

Another purpose of the present invention is to provide a joining system for augers of modular construction, specifically those where power is transmitted from one auger section to the next, and that does not require chassis-mounted supports within the auger trough that could obstruct the grain flow conveyed by the collecting-conveyor auger. A main purpose of the present invention is to add additional auger modules without chassis supports that could interfere with the transit of the transported material. Another purpose of the present invention is to obtain modules for an auger unit that can be assembled to the drive module, ensuring a sufficiently precise collinearity between the auger modules to prevent generating additional vibration during field operation and avoiding intermediate supports, except for the mutual support between auger modules through the coupling and, eventually, an intermediate support provided by the drive assembly to the main module for maintaining grain flow along the auger.

As used herein, the term “collinearity” refers to the ability of the assembled modules to rotate coaxially. By absence of “intermediate” supports it is meant that there are no supports for the auger at any point that would significantly obstruct the transportation of the material collected by the auger trough.

A third purpose of the present invention is to provide a coupling sleeve or flange for joining two modules of an auger unit, ensuring a robust connection and sufficiently precise collinearity between the auger modules so as not to introduce appreciable vibration during field operation.

To address the challenges related to assembling two auger modules together without the need for chassis-mounted supports, the present invention includes a sleeve or flange that is firmly fixed inside the tubular body of one of the auger modules. This sleeve comprises a cylindrical or tubular body with an outer diameter smaller than the inner diameter of the auger tube, so that it fits within the rotary auger body in such a way that part of the sleeve remains inside one module and is securely attached thereto, while the remaining portion extends into the other module. According to the invention, these portions of the sleeve include respective pairs of rings affixed to the sleeve body, dimensioned to compensate for the difference between the internal diameter of the auger tube and the external diameter of the sleeve body.

It is convenient to fix the sleeve by welding inside the first auger module, using spot welds applied to the inner ring through holes pre-drilled in the sidewall of the module, thereby ensuring alignment of the sleeve with the auger module's axis. It is worth noting that this type of radial “spot” welding avoids deformation—which is particularly important in this application—while providing the robustness or rigidness required for power transmission. Once aligned and fixed in place, a continuous weld bead is applied around the outer ring, which remains visible at the end of the auger module. The distance between both rings is dimensioned to ensure the required alignment precision. The second auger module is then secured to the sleeve using bolts inserted through two sets of holes in the sidewall of that module and screwed into corresponding threaded holes in both rings of the sleeve.

In addition to being sufficiently robust to withstand the bending stresses to which augers are subjected due to the nature of the task it performs (transporting material by friction along a trough) and the extensive spans required by wide harvesting widths, this configuration offers the advantage of eliminating any type of flow restriction related with conventional supports and their plates. This is so because such supports are dispensed with, the risks of material warping are eliminated, alignment procedures are avoided, and the flow of material is ensured by the continuity in the spiral flight.

### BRIEF DESCRIPTION OF DRAWINGS

Both the main purpose of the invention and the advantages achieved may be better understood according to the following description of a preferred embodiment, with reference to the accompanying figures, in which:

FIGS. 1A and 1B, above-referred to in this specification, are top-view schematic diagrams illustrating two possible configurations of a modular sunflower harvesting header according to the present invention.

FIG. 2 is a top plan view of a sunflower harvesting header, with some components such as the shield and reel removed in the upper portion to reveal its modular collector-conveyor auger mounted at the ends on lateral extensions of a modular chassis, according to a preferred embodiment of the present invention.

FIG. 3A is a vertical cross-sectional view through the collector-conveyor auger of the sunflower header shown in FIG. 2, depicting a region of the chassis and auger to be joined prior to assembly of respective modules, according to a preferred embodiment of the present invention. FIG. 3B is a cross-sectional view similar to FIG. 3A, showing the respective pairs of chassis and auger modules firmly assembled.

FIG. 4 is a side elevation view showing the flange or bracket of a lateral module used to extend the working width of the sunflower harvesting header shown in FIG. 2.

FIG. 5A is a magnified rear vertical sectional view through the flanges of two modules, illustrating the bolted connection area between chassis modules of the sunflower harvesting header of FIG. 2, with both modules shown separated prior to assembly. FIG. 5B is a similar sectional view with the modules already assembled. FIGS. 5A and 5B depict a slight variation with respect to FIGS. 3A and 3B, specifically in the positioning of a threaded bushing within the module alignment system.

FIG. 6 is a perspective view of the joint area between chassis modules as shown in FIG. 5B.

FIG. 7 is a perspective view of the end of the main auger module from FIG. 2, with the tubular body of the auger rendered transparent to better illustrate the first step of the assembly process, consisting of the insertion of a sleeve, according to a preferred embodiment of the present invention.

FIG. 8 is a perspective view of the sleeve used in FIG. 7 for assembling modules of a collector-conveyor auger, according to a preferred embodiment of the present invention.

FIG. 9 is another perspective view of the end of the main auger module from FIG. 7 after the first step of the auger assembly process, involving insertion of the sleeve from FIG. 8.

FIG. 10A is a perspective view showing the ends of two auger modules presented for pre-assembly, with the sleeve from FIG. 7 inserted and welded into the main module of FIG. 8 and the fastening elements ready for securing the second module, according to a preferred embodiment of the present invention. FIG. 10B is a view similar to FIG. 10A showing both auger modules assembled.

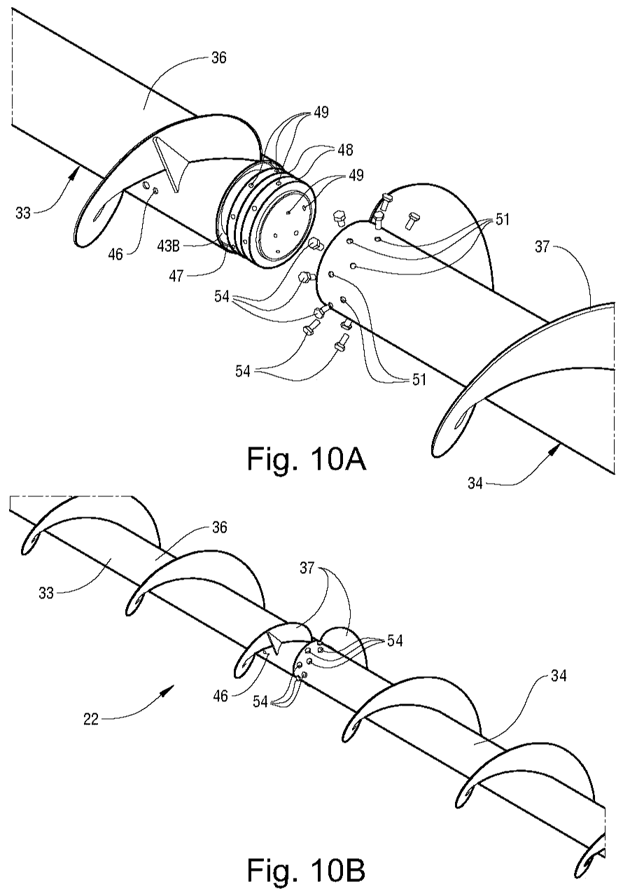

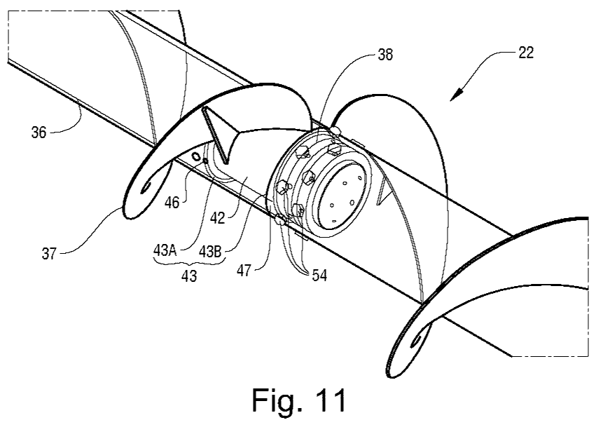

Finally, FIG. 11 is a perspective view of the assembly area between auger modules from FIG. 10, with the tubular body rendered transparent to better illustrate the joint according to a preferred embodiment of the present invention.

In all figures, identical references correspond to identical or equivalent elements of the harvesting header.

### DETAILED DESCRIPTION OF THE INVENTION

### Modular Header

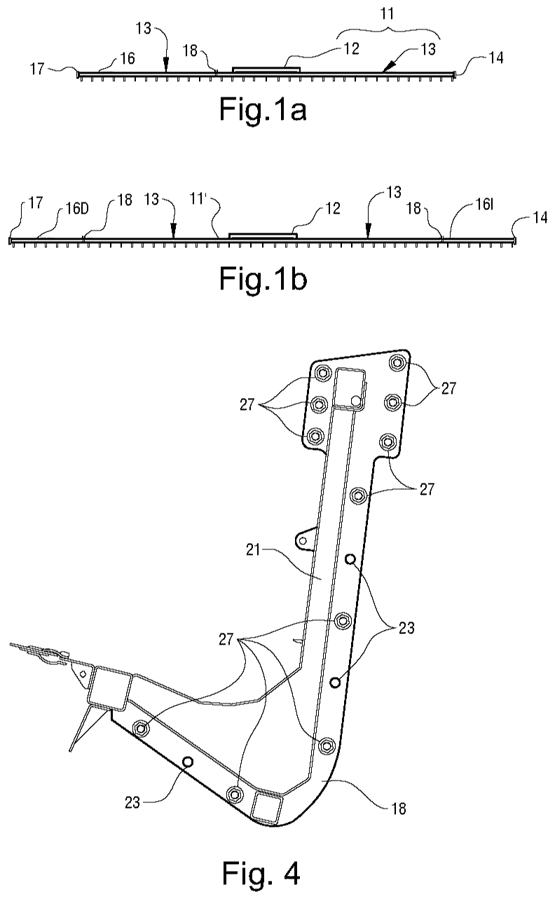

FIG. 2 depicts a sunflower harvesting header with a total of 52 pans 19 spaced at 52.5 centimeters between planting rows, manufactured in three modules, namely: a central module 11′ carrying thirty-six pans 19, and two lateral modules 16D and 161 (collectively referred to as minor modules 16′) each carrying eight pans 19, adopting the configuration shown in FIG. 1B.

Various transversally moving components are mounted on its structural chassis 21, i.e, extending across the entire width, including a collector-conveyor auger 22 (in addition to a reel, a stalk puller, and a sickle bar not illustrated herein, as their general arrangements are disclosed in Argentine patent publications AR 129,781 A1 and AR 131,467 A1 (incorporated herein by reference). Both the chassis 21 of the header and its transverse components—including the auger 22—are modularly constructed with the purpose of allowing disassembled transport in containers. Thus, each header module 11 and 16′ includes its own cutting elements, stalk puller, reel, shield, and auger 22, meaning that modularity also applies to the other components mounted on the chassis.

According to this preferred embodiment of the invention, one of the modules—referred to as the main module, major module 11 or central module 11′—includes the central portion 12 of the header with the grain outlet and the power take-off for driving the moving components (not illustrated). The major module 11 or 11′ is dimensioned to a maximum length that allows it to be marketed without lateral modules as a header with a smaller working width. Of the two minor modules 16′, the left lateral module 161 carries, on its outer edge 14, a drive for the stalk puller (and optionally other drives).

The drives that transmit power from the header's power take-off (PTO) to the auger mechanism—and eventually through various branches to other moving parts such as the reel and sickle bar—can conveniently be arranged entirely within the central module 11′ using a drive arrangement as proposed in the aforementioned patent publication AR 131,467 A1. In this case, the outer edge 17 that closes the end of the other lateral or minor module 16D located on the right side of the header does not need to house mechanisms for these drives. Since the central module 11′ concentrates the central drives for the sickle bar, auger 22, and reel, it can operate independently without lateral modules 16′ if the header width corresponds to this total working width. In such case, the outer edge 14 having the lateral stalk puller drive is mounted on the left lateral module 161, always within its working width.

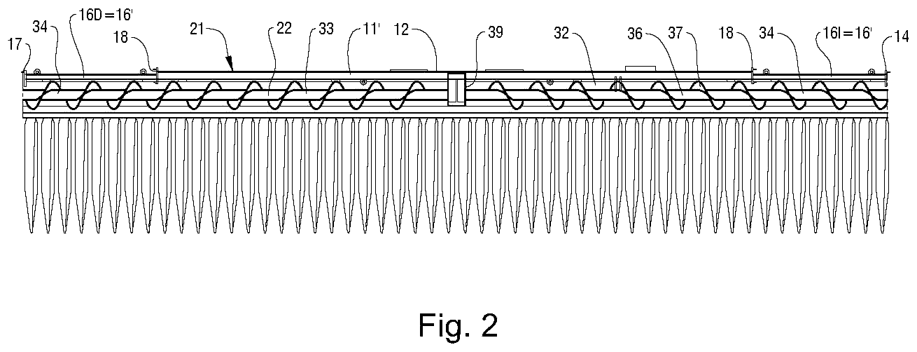

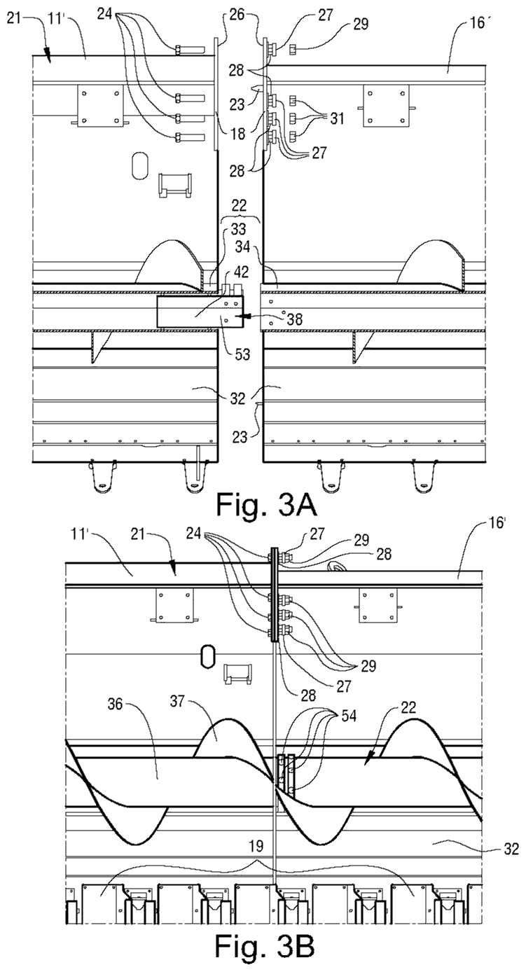

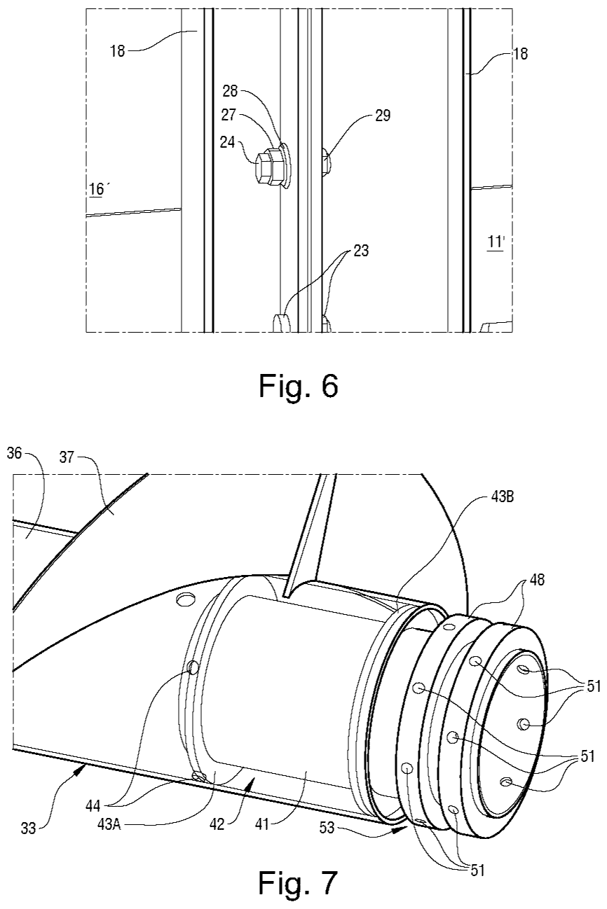

In disassembled mode, the modules can be stored in standard containers not illustrated) for transport to another site—for example, exported to another country where the modules 11′ and 16′ may be quickly assembled as shown in FIG. 3B to put the header into service. Thus, the header can be transported with each container carrying multiple modules, each with their fastening mechanisms as shown in FIGS. 3A to 6, to be assembled at the destination by an assembly procedure described further below.

To obtain wider headers, additional modules 16D and 161 are added to the central module 11′, bolted onto both sides. For this, the sides of both the central module 11′ and the lateral modules 16′ terminate in flat flanges formed by end plates 18 which are bolted together or eventually, the outer edges 14 or 17 are bolted in case there are no lateral extensions 16′. The procedure to join one module 16′ to another 11′ of the chassis 21 is illustrated in FIGS. 3A and 3B. FIG. 3A shows the parts of two modules 11′ and 16′ prior to their joining.

As shown in FIGS. 3A and 4, the lateral modules 16′ include three guide pins or bolts 23 that are designed for an initial easy and simple engagement. Once the end plates 18 of the chassis modules to be joined 11′ and 16′ are positioned and the guide pins 23 of the lateral module 16′ are engaged in holes (not illustrated) of the central module 11′, the flange plates 18 are joined by bolts or screws 24. FIG. 4 shows the positions of the engagement pins 23 and the fastening bolts 24 on one of the flange plates 18.

A very important consideration in the modularization of the harvesting header is the precision of alignment between modules 11′ and 16′ in the final assembly thereof, taking into account that the ends of the chassis house the supports for transverse rotating components such as the auger 22, reel and stalk puller, in order to avoid causing vibrations and premature wear. When welding the flange plates or edge plates 18, the sheet metal can deform into unpredictable shapes. One possible solution to ensure that both flange plates 18 present flat faces 26 that rest well and that modules 11′ and 16′ are properly aligned would be to machine the faces 26 to be joined on the modules 11′ and 16′ after welding the flange plates 18 to the chassis 21; however, the dimensions of such large parts would require a costly large machining center to machine those faces.

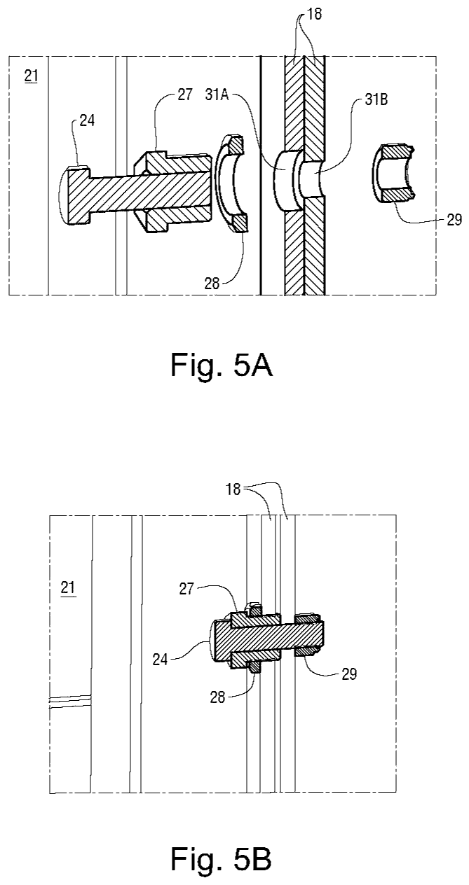

To overcome this problem, the bolts 24 are mounted inside a bushing 27 with an external thread upon which a lock nut 28 is threaded. FIGS. 4 and 5A show how different sized holes 31A-31B have been made in the flange plates 18 of each module so that they face each other once modules 11′ and 16′ are presented for assembly. The bushing 27 passes through the large hole 31A of one flange plate 18 and, as illustrated in FIG. 5B, it abuts the adjacent flange plate that has a smaller hole 31B allowing only the bolt 24 to pass through. Once aligned—there may be some clearance somewhere between the flange plates 18—the lock nut 28 is tightened to lock everything in place. Finally, the nut 29 is tightened on the bolt 24, pressing it against the flange plate 18 (FIG. 3B) or against the bushing 27 (according to the alternative of FIG. 5B).

The threaded bushing 27 and lock nut 28 allow both sections to be properly aligned while providing a solid and simple attachment, compensating for any misalignment that might exist in the coupling flanges 18. With three guide pins 23 and eleven attachment bolts 24 per flange 18, the resulting union—illustrated in FIGS. 3B, 5B, and 6—is solid and correctly aligned, ensuring the required reliability. The guide pins 23 serve merely to position the modules and facilitate the placement of the bushings 27 and bolts 24 but do not contribute to the overall alignment of the flat faces 26.

### Collector-Conveyor Modular Auger

The modules of moving parts such as the reel, stalk puller, and sickle bar can be conventionally joined by intermediate supports (not illustrated). In contrast, with the auger mechanism 22, it is advantageous to dispense with intermediate supports that obstruct the transport of collected material-heads and seeds-through the trough 32 toward the central area 12 of the header to reach the outlet.

Each auger module 33; 34 comprises a cylindrical body 36, tubular at least at one of its ends, around which a helix 37 in the form of a feeding screw is formed.

FIG. 7 shows the main module 33 of the collector-conveyor auger 22, inside which a sleeve or coupling 38 has been inserted according to the novel flange joining system in the auger mechanism 22 that avoids intermediate supports between the auger 22 and chassis 21. The only supports for the auger 22 are found at both edges 14 and 17 of the chassis 21 of the header and in a central control box 39 (which is the subject of the previously mentioned patent publication AR 131,467 A1) to avoid interference with the space between the auger 22 and the header trough 32.

### Auger Modules Assembly

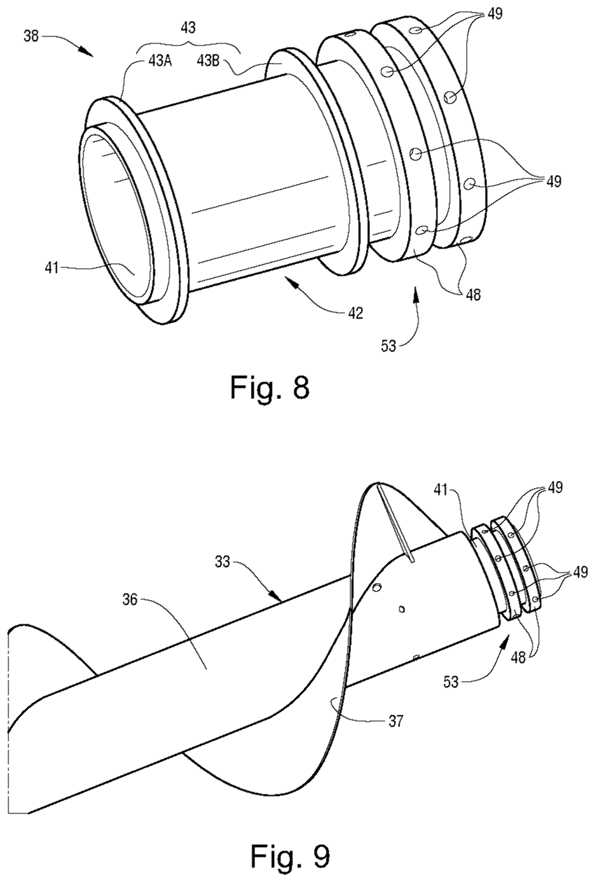

FIG. 8 shows the sleeve 38 consisting of a tubular body 41 whose external diameter is smaller than the internal diameter of the auger modules 33 and 34, and includes a first portion 42 with a pair of centering flanges formed by rings 43 separated by a sufficient distance to limit misalignment deviations during assembly—the greater the distance, the better—since the farther apart these rings 43 are, the less misalignment effect any possible gap between the pieces 36 and 43 will have, making it easier to ensure their collinearity in the welding device and provide greater robustness to the joint. Such distance between the rings 43 may be greater than the external diameter of the tubular body 41 of the sleeve 38.

Likewise, the tubular body 36 of this auger module 33 has a series of through holes 44 distributed around its cylindrical wall corresponding to the ring 43A positioned deeper inside the end of module 33, from which weld spots 46 are applied to immobilize the sleeve 38 in the aligned and centered position shown in FIG. 9, in a welding device (not illustrated) that ensures the collinearity of the sleeve after welding. In this way, the sleeve 38 is coaxially immobilized inside one of the modules of the auger mechanism 22—preferably the main module 33—preventing any sliding during the assembly process stage. It may be noted that this type of radial tack welding 46 avoids deformations—which is very important in this application—while also ensuring the necessary robustness for power transmission.

The sleeve 38 is thus firmly fixed to the main auger module 33 by an annular weld seam 47 applied to join the ring 43B adjacent to the end of module 33. In this semi-assembled state of the auger mechanism shown with the sleeve 38 welded inside the tubular body 36 of the main module 33 (FIGS. 7 and 9), it can be transported in a standard container to another location to complete the assembly of the auger mechanism 22.

Referring back to FIGS. 8 and 10A, a second pair of rings 48 are welded to the portion of the sleeve 38 that protrudes from the main auger module 33. These rings serve to center the smaller module 34 by sliding it over the sleeve as shown in FIG. 9. This second pair of rings 48 may be spaced closer together compared to the first pair of rings 43 welded inside the main module 33 to avoid excessive dimensions in case no modules are added (eighteen-row header without extensions). Also, since this second pair is bolted rather than welded, the clearance in the holes 44 allows to eliminate possible misalignments.

The second pair of rings 48 are thicker compared to the first pair 43, sufficient thickness to allow the machining of threaded holes 49 distributed around the outer face of each ring 48, as shown in FIG. 8. In contrast, the first pair of rings 43 are thinner to facilitate the insertion of the sleeve 38 into the main auger module 33 of the auger mechanism 22. Both pairs of rings 43 and 48 are sized to accommodate the difference between the internal diameter of the tubular auger body 22 and the external diameter of the sleeve's body 41.

The smaller module 34 of the auger mechanism 22 is provided with two series of through-holes 51 distributed around the cylindrical perimeter of its tubular lateral wall 36, aligned with the threaded holes 49 of the second pair of rings 48 on the sleeve. After fitting the tubular end 52 of the smaller auger module 34 onto the protruding portion 53 of the sleeve, as shown in FIGS. 10A, 10B and 11, these holes receive bolts 54 or suitable fastening elements that securely join the tube 36 of the smaller auger module 34 to the sleeve 38. This ensures the collinearity of both parts 33 and 34, preventing vibrations of the auger mechanism 22 during rotation, maintaining the continuity of the spiral flights 37 under the loads they must carry, and, fundamentally, avoiding the need for bearing supports between the auger 22 and chassis 21 that could obstruct the normal flow of transported material and require laborious alignment during assembly. These through holes 51 in the wall of the smaller module 34 have a slightly larger diameter than the adjustment bolts 54 to allow proper alignment and collinearity during assembly.

Since the main module 28 will have the sleeve 38 welded and the smaller module 34 will be fixed to it by bolts 54, in cases where extensions to increase the working width are not required, the same construction system—a sleeve 38 bolted via a pair of centering discs 48—is used to fix the shaft tip that serves as the lateral support of the auger 22.

### Additional Embodiments

Particular embodiments of a modular chassis 21 and an auger 22 that may be assembled in modules without supports that invade the trough area of a sunflower harvesting header have been previously described, notwithstanding possible changes in materials, shapes, dimensions, geometry, construction, application and arrangement of components without departing from the scope of the present invention as defined in the following claims. It is evident that countless variants and configurations can be introduced. For example, the specification refers particularly to an auger assembly 22 as the collecting-conveyor element in a sunflower harvesting header, without excluding the application of the present invention to other types of conveying elements with similar challenges such as draper belts or conveyor belts). Also, the invention adopts the configuration of FIG. 1B without excluding the possibility of adopting the configuration of FIG. 1A or other similar foreseeable arrangements. Thus, the reference to a main module applies equally to what is called the larger module 11 as well as the central module 11′. Furthermore, for commercial purposes, sunflower harvesting headers with a total of 60 or 68 pans 19 with row spacing of 52.5 centimeters have been specifically envisaged, with main modules for 18 rows (9.45 meters) and lateral modules for 22, 24, and 26 rows (11.55, 12.6, and 13.65 meters respectively), all at 52.5 mm spacing.

Likewise, a coupling sleeve 38 has been described for assembling a module to an auger mechanism 22 without any support other than that provided by the mutual assembly at the intermediate zone, where the sleeve 38 is initially welded to the main module 28, without prejudice to other attachment options such as set screws tightened against the rings 43 of the sleeve to retain it in the main auger module 33, for example. An alternative has also been foreseen to weld the sleeve first to the lateral module so that no portion of the sleeve protrudes from the main auger module in the event that no additional modules are added. However, welding the sleeve to the main or larger module, in the preferred embodiment of the invention, offers the advantage that the drive comes from the center towards the ends of the central auger drive, and the welded sleeve acts as a transmitter while the bolted segment acts as a receiver, being smaller in dimensions—and therefore load—as well as the least stressed segment of the auger, since the amount of material transported increases from the outside towards the center.

1. A method for assembling an auger module collinearly with another auger module to extend the length of an auger device in a harvesting header, with a sleeve made with a first portion having a cylindrical surface sized to fit tightly inside a tubular end of the first auger module and a second cylindrical portion of smaller diameter than the second auger module around which at least two rings are fixed, sized to fit tightly inside a tubular end of the second auger module, both auger modules comprising a series of spiral flights affixed to a tubular or cylindrical body; said method comprising the steps of:
(a) inserting the first cylindrical portion of the sleeve into the tubular end of the first auger module, leaving a second cylindrical portion of the sleeve protruding outside said first sleeve portion;
(b) aligning the sleeve with the first auger module;
(c) firmly affixing the aligned sleeve inside the first auger module
(d) fitting the tubular end of the second auger module onto said rings of the second cylindrical portion of the sleeve that projects outside the first sleeve portion; and
(e) firmly affixing the second auger module around the sleeve.

2. The assembly method according to claim 1, wherein step (c) comprises welding the first portion of the sleeve through holes made in the wall of the first auger module.

3. The assembly method according to claim 2, wherein the welding step (c) comprises:
applying weld spots radially to an internal centering ring or disc on the first portion of the sleeve through holes made in the wall of the first auger module; and
applying a weld seam to an external centering ring or disc on the first portion of the sleeve near the end of the first auger module where the second auger module will be assembled.

4. The assembly method according to claim 1, wherein step (e) comprises passing bolts, screws or similar fastening elements through a series of through-holes distributed around the wall of the second auger module and screwing them into threaded holes made in the rings of the second sleeve portion corresponding to said through holes in the second auger module wall.

5. The assembly method according to claim 1, wherein in step (b) the sleeve is rotated inside the first auger module to verify collinearity between both.

6. The assembly method according to claim 1, wherein in step (b) an optical system is used to verify the collinearity between the sleeve and the first auger module.

7. The assembly method according to claim 1, wherein steps (d) and (e) are carried out at a different site than steps (a), (b), and (c), and between step (c) and step (d) the modules, with the sleeve firmly fixed inside the first of them, are transported in containers from one site to the other.

8. A sleeve to join two modules of a rotating tubular device, comprising a cylindrical or tubular body configured, to fit inside said rotating device such that a first portion of the sleeve is configured for insertion inside one first of said modules and a second remaining portion of the sleeve inside the other module of the rotating device;
wherein the sleeve further comprises: a first pair of centering rings on the first portion and a second pair of centering rings on said second portion of the sleeve, both pairs fitted to the difference between the internal diameter of the tubular device and the external diameter of the cylinder or tube;
wherein at least one of the rings of the second portion having holes provided in its cylindrical lateral face configured for receiving fastening elements.

9. The sleeve according to claim 8, wherein both rings of the second portion are provided with threaded holes to receive fastening bolts.

10. The sleeve according to claim 8, wherein the centering rings of the first portion are thinner than those of the second portion.

11. The sleeve according to claim 8, wherein the rings of the first portion are spaced further apart than the rings of the second portion.

12. The sleeve according to claim 11, wherein the distance between the centering rings of the first portion is greater than the external diameter of said cylinder or tube.

13. An auger device comprising:
a first auger module and at least a second auger module, each auger module comprising:
a tubular or cylindrical body having an end portion each joined to the end portion of the other auger module;
spiral flights affixed about said body of each of said auger modules; and
a sleeve comprising a cylindrical or tubular body whose external diameter is smaller than the internal diameter of the auger body so as to fit inside said auger body, said sleeve having a first sleeve portion affixed inside the first auger module and a remaining second sleeve portion affixed inside the second auger module, whereby said sleeve rigidly joins said bodies of the auger modules to one another;
wherein the sleeve further comprises: a first pair of centering rings on the first portion and a second pair of centering rings on said second portion of the sleeve, both pairs fitted to the difference between the internal diameter of the tubular device and the external diameter of the cylinder or tube;
at least one of the rings of the second portion having holes provided in its cylindrical lateral face configured for receiving fastening elements;
the first auger module having at least one series of through-holes distributed around the cylindrical periphery of its tubular or cylindrical body corresponding to at least one of the centering rings of the first portion of the sleeve for applying first fastening elements of the sleeve to the first auger module; and
the second auger module having at least a series of holes distributed around the cylindrical periphery of the tubular or cylindrical body of the auger device corresponding to one of the rings of the second pair of rings of the sleeve to which second fastening elements are applied to retain the second auger module on the second sleeve portion.

14. The auger device according to claim 13, wherein said first fastening elements comprise radial weld spots applied to the innermost ring of the first pair of rings of the first portion of the sleeve through said through holes in the cylindrical body wall of the first auger module.

15. The auger device according to claim 14, wherein said first fastening elements are completed with a weld seam that fixes the outermost ring of the first pair of rings to the cylindrical wall of the body of the first auger module.

16. The auger device according to claim 13, wherein said second fastening elements comprise adjustment bolts passing through said holes in the tubular body wall of the second auger module and screwed into respective threaded holes made radially in said second pair of rings of the sleeve, coincident with those through holes in the tubular body wall of the second auger module, which in turn have a slightly larger diameter than the adjustment bolts.

17. The auger device according to claim 13, wherein said first fastening elements include adjustment bolts.

18. The auger device according to claim 13, wherein the first auger module is longer than the second auger module.

19. A harvesting header with a collecting-conveyor device mounted inside a chassis for transporting harvested material dumped into the collecting-conveyor device towards a feeder at a rear structure of the chassis and a drive mechanism for driving the collecting-conveyor device; wherein the chassis comprises at least two modules assemblable by reciprocal fastening devices provided on both chassis modules, one first of the assemblable modules being a main module that contains the mounting apparatus of the header on the harvesting machine, said feeder, and said drive mechanism.

20. The harvesting header according to claim 19, wherein the reciprocal fastening devices comprise flanges or end plates on the sides of the modules, which are firmly fastened together.

21. The harvesting header according to claim 20, wherein the flange connection comprises bolts mounted inside a bushing with external threads onto which, in turn, a lock nut is screwed.

22. The harvesting header according to claim 20, wherein the flange of at least one smaller module of said modules has guides that fit into at least one flange of another module to allow preliminary alignment of both modules before bolting or firmly joining said flanges.

23. The harvesting header according to claim 22, wherein said guides comprise pins or bolts fixed to the flange of at least one smaller module that fit into corresponding holes in the flange of the main module.

24. The harvesting header according to claim 21, wherein said guides comprise pins or bolts fixed to the flange of at least one smaller module that fit into corresponding holes in the flange of the main module, and each pair of flanges is aligned with three guide pins and firmly secured with eleven fastening bolts per flange.

25. The harvesting header according to claim 19, wherein the rear structure of the chassis spans the entire width of the header, the first module being larger in size than the remaining module and containing the central part and one lateral side of the harvesting header, while the remaining chassis module contains at least most of the other lateral side of the harvesting header.

26. The harvesting header according to claim 19, further including a chassis and a collecting-conveyor device constituted by auger modules, each housed in one of said respective chassis modules, the auger module housed in said remaining chassis module mounted without bearings or other intermediate supports in said chassis.

27. The harvesting header according to claim 26, wherein the collecting-conveyor device thus assembled presents supports in the chassis at both ends of the device and a single intermediate support by means of a drive box supported from above from said chassis.

28. The harvesting header according to claim 26, wherein said first module additionally contains drive mechanisms for driving other movable components of the harvesting header including the sickle bar, auger, and the stalk puller.
